(19) United States
(12) Patent Application Publication
(10) Pub. No.: US 2023/0230352 A1
(43) Pub. Date: Jul. 20, 2023

(54) METHODS AND SYSTEMS FOR CONTEXTUAL SMART COMPUTER VISION WITH ACTION(S)

(71) Applicant: BABU VINOD, PALO ALTO, CA (US)

(72) Inventor: BABU VINOD, PALO ALTO, CA (US)

(21) Appl. No.: 17/964,000

(22) Filed: Oct. 11, 2022

Related U.S. Application Data
(60) Provisional application No. 63/254,430, filed on Oct. 11, 2021.

(51) Int. Cl. G06V 10/764; G06V 10/774; G06V 20/50; G06V 10/82

(52) U.S. Cl. CPC G06V 10/764; G06V 10/82; G06V 10/774; G06V 20/50

(57) ABSTRACT

In one aspect, a computerized method for contextual smart computer vision comprising: with a digital camera of a mobile device, obtaining a digital image of a computer screen, wherein the computer screen is displaying a specified computing application; with a machine learning algorithm: obtaining a set of training digital images of computer screens and associated contextual actions, and using the machine learning algorithm to build and train a machine learning classifier based on the set of training digital images of computer screens and associated contextual actions; and using the machine learning classifier to classify the digital image and determine a specific application action based on the classification of the digital image; and based on context, the mobile application suggests specified contextual actions.

### CLAIM OF PRIORITY

This application claims priority to U.S. Provisional Pat. Application No. 63254430, filed on 11-OCT-2021, and titled METHODS AND SYSTEMS FOR CONTEXTUAL SMART VISION WITH ACTION(S). This provisional patent application is hereby incorporated by reference in its entirety.

### BACKGROUND

It is noted that, professionals may carry and use multiple digital devices, typically at least a smartphone and a laptop computer. The mobile phone may be used for messaging applications (e.g. Whatsapp®, etc.) and/or quick access to the calendar, whereas the laptop may be used for content-heavy work such as detailed emails or document viewing and editing.

From time to time, it may be desirable to enable live context sharing between the laptop and the mobile phone. For instance, the user may want to share the summary of an email received via the messaging application (e.g. Whatsapp®, etc.) or via a LinkedIn® application installed in the smartphone. Today there does not exist usable technology to enable such multi-device, contextual interactions.

### SUMMARY OF THE INVENTION

In one aspect, a computerized method for contextual smart computer vision comprising: with a digital camera of a mobile device, obtaining a digital image of a computer screen, wherein the computer screen is displaying a specified computing application; with a machine learning algorithm: obtaining a set of training digital images of computer screens and associated contextual actions, and using the machine learning algorithm to build and train a machine learning classifier based on the set of training digital images of computer screens and associated contextual actions; and using the machine learning classifier to classify the digital image and determine a specific application action based on the classification of the digital image; and based on context, the mobile application suggests specified contextual actions.

### BRIEF DESCRIPTION OF THE DRAWINGS

FIG. 1 illustrates an example process used for contextual smart vision with action(s), according to some embodiments.

FIG. 2 illustrates an example process for utilizing contextual smart vision with action(s), according to some embodiments.

FIG. 3 is a block diagram of a sample computing environment that can be utilized to implement various embodiments.

FIG. 4 illustrates an example image processing and machine learning system, according to some embodiments.

FIG. 5 illustrates an example process for computerized method for contextual smart computer vision, according to some embodiments.

The Figures described above are a representative set and are not an exhaustive with respect to embodying the invention.

### DESCRIPTION

Disclosed are a system, method, and article of manufacture for contextual smart vision with action(s). The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Deep learning is part of a broader family of machine learning methods based on artificial neural networks with representation learning. Learning can be supervised, semi-supervised or unsupervised.

Deep neural network (DNN) is an artificial neural network (ANN) with multiple layers between the input and output layers. There are different types of neural networks but they always consist of the same components: neurons, synapses, weights, biases, and functions.

Computer vision is an interdisciplinary scientific field that deals with how computers can gain high-level understanding from digital images or videos. From the perspective of engineering, it seeks to understand and automate tasks that the human visual system can do. Computer vision tasks include methods for acquiring, processing, analyzing and understanding digital images, and extraction of high-dimensional data from the real world in order to produce numerical or symbolic information, e.g. in the forms of decisions. Understanding in this context means the transformation of visual images (e.g. the input of the retina) into descriptions of the world that make sense to thought processes and can elicit appropriate action. This image understanding can be seen as the disentangling of symbolic information from image data using models constructed with the aid of geometry, physics, statistics, and learning theory. As used herein, a computer visional functionality and/or system can use, inter alia: DenseCap systems/functionalities, scene reconstruction, object detection, event detection, video tracking, object recognition, 3D pose estimation, learning, indexing, motion estimation, visual servoing, 3D scene modeling, and image restoration.

Convolutional neural network (CNN) is a class of artificial neural network (ANN), most commonly applied to analyze visual imagery. CNNs can be based on the shared-weight architecture of the convolution kernels or filters that slide along input features and provide translation-equivariant responses known as feature maps. CNN can be used for various object detection, image recognition, etc. performed herein.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, logistic regression, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees’ habit of overfitting to their training set. Deep learning is a family of machine learning methods based on learning data representations. Learning can be supervised, semi-supervised or unsupervised.

Messaging application can include a cross-platform centralized instant messaging (IM) and voice-over-IP (VoIP) service.

Object detection is a computer technology related to computer vision and image processing that deals with detecting instances of semantic objects of a certain class in digital images and videos.

User interface (UI) is the space where interactions between humans and machines occur. A UI can include a graphical user interface (GUI) as a form of UI that allows users to interact with electronic devices through graphical icons and audio indicator such as primary notation.

The elements described in this definition section can be utilized in various embodiments provided infra.

### Example Systems and Methods

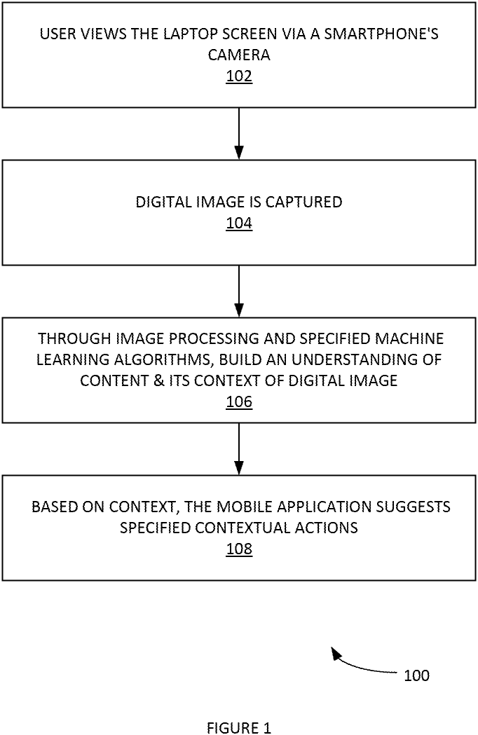

FIG. 1 illustrates an example process 100 used for contextual smart vision with action(s), according to some embodiments. Process 100 can enable a live context sharing between smart devices. In step 102, the user views the laptop screen (and/or a specific window) via a smartphone’s camera. In step 104, the digital image is captured. In step 106, through image processing and specified machine learning algorithms, process 100 builds an understanding of the content and its context of the digital image. This can be implemented by an application in the smartphone. It is noted that in other example embodiments, another type of mobile device (e.g. a tablet computer, etc.) can be utilized in lieu of a smart phone. In step 108, based on the context, the mobile application can suggest specified contextual actions. These contextual actions can include, inter alia: sharing, via Whatsapp® or adding an event to the personal calendar. The mobile application can be a client application runs on mobile devices but is also accessible from desktop computers.

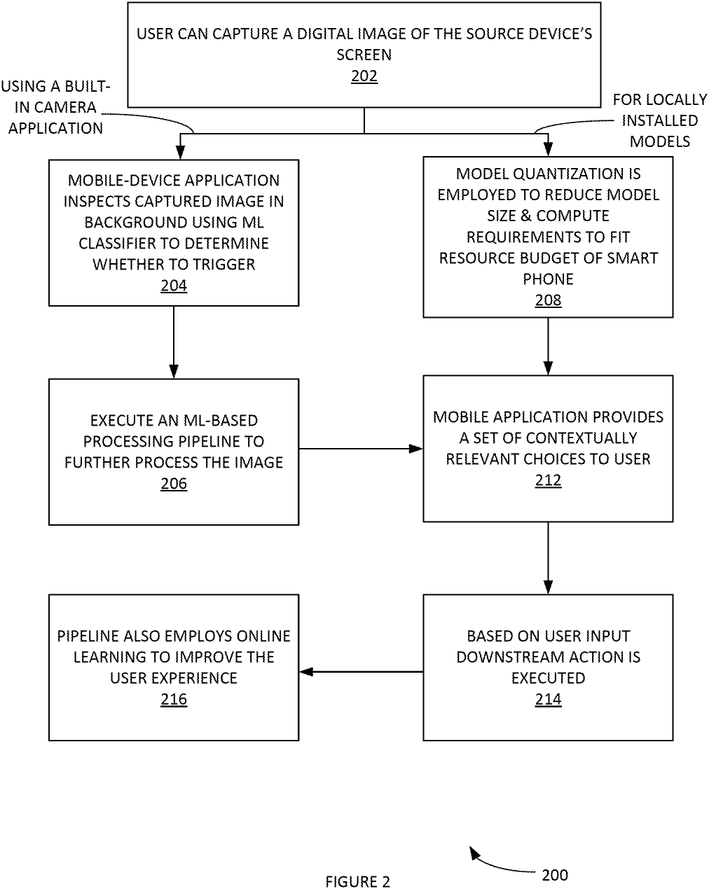

FIG. 2 illustrates an example process 200 for utilizing contextual smart vision with action(s), according to some embodiments. It is noted that one embodiment of process 200 is implemented as a smartphone application that may execute in both foreground and background modes. In step 202, a user can capture a digital image of the source device’s (e.g., a laptop) screen. This can be performed by using a mobile-device application and/or by using a built-in camera application. In the latter case, in step 204, the mobile-device application inspects the captured image in the background using a Machine Learning (ML) classifier to determine whether to trigger its processing or not.

In step 206, based on the ML classifier decision, it executes an ML-based processing pipeline to further process the digital image. The ML-based processing pipeline is defined in a modular way by composing task-specific state-of-the-art ML models for functions such as image normalization, deep learning-based object detection, content extraction, content summarization and image classification. The pipeline may execute in a hybrid fashion, with a mixture of locally executing ML models and cloud-based models.

For locally installed models, in step 208, model quantization is employed to reduce the model size and compute requirements to fit the resource budget of the smart phone. It is noted that processing operations involving large deep learning models can be offloaded to the cloud. This hybrid pipeline enables optimization on the speed of execution. Based on the execution of the ML pipeline, the mobile application provides a set of contextually relevant choices to the user in step 210.

In step 212, based on the user input downstream action is executed (e.g. posting a Whatsapp® message and/or adding an event to the personal calendar). Based on the user feedback the pipeline also employs online learning to improve the user experience. During the training phase, the pipeline may be optimized using reinforcement learning.

### Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees’ habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model’s hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

### Additional Example Computer Architecture and Systems

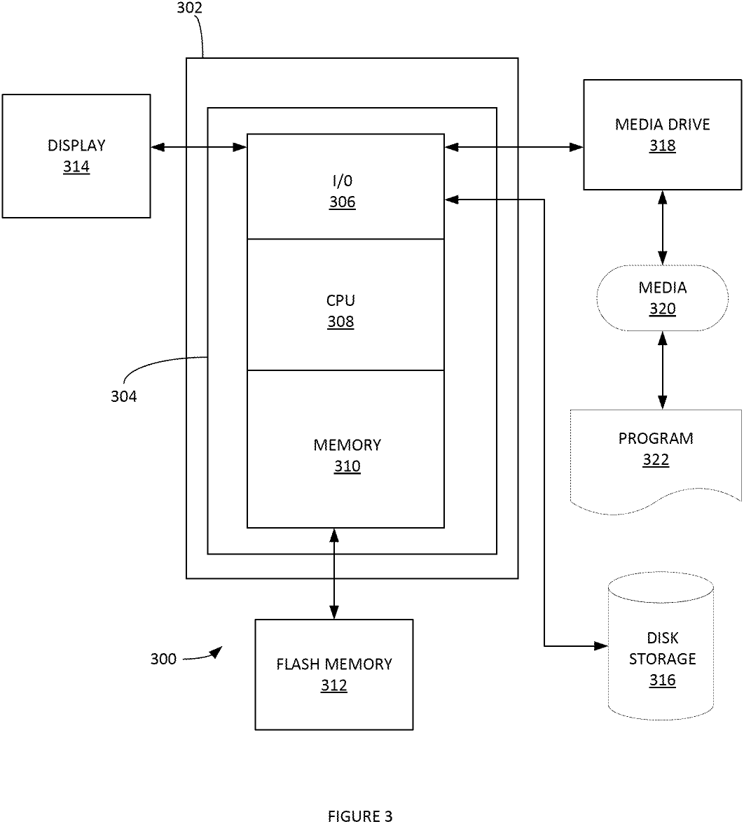

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

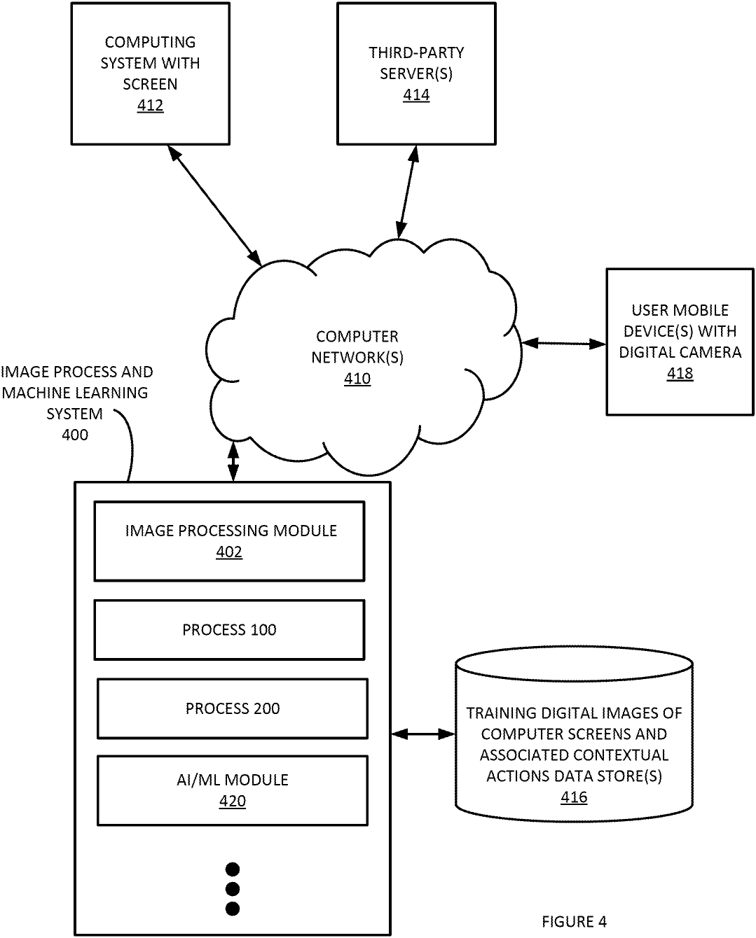

FIG. 4 illustrates an example image processing and machine learning system 400, according to some embodiments. Image processing and machine learning system 400 can include image processing module 402. Image processing module 402 can implement various computer vision functionalities. This can include object detection and/or recognition systems. Object recognition (e.g. can include object classification) includes a process where several pre-specified or learned objects or object classes can be recognized, usually together with their 2D positions in the image or 3D poses in the scene. These can include, inter alia: Blippar, Google Goggles, and like.

Image processing module 402 implements objection identification. Image processing module 402 can determine/recognize an individual instance of an object. Examples include identification of a specific application, input field, context of a computer application, functionality of an application interface element, etc.

Image processing module 402 includes object detection. Image processing module 402 can scan the image data for a specific condition. Examples include the detection of possible abnormal cells or tissues in medical images or the detection of a vehicle in an automatic road toll system. Detection based on relatively simple and fast computations ca be used for locating smaller/sub regions of image data which to be further analyzed by more computationally demanding techniques to produce a correct interpretation.

Image processing and machine learning system 400 can include the set of training digital images of computer screens and associated contextual actions 416. The set of training digital images of computer screens and associated contextual actions 416 can be pre-generated by various input systems. The set of training digital images of computer screens and associated contextual actions 416 can also be provided/update by a system administrator.

Image processing and machine learning system 400 can include computing system with screen 412. Computing system with screen 412 can run/access various computer-based applications that image processing module 402 operates on.

Image processing and machine learning system 400 can include user mobile device(s) with digital camera 418. User mobile device(s) with digital camera 418 can obtain a digital image an image of a screen of computing system with screen 412 or a sub-portion thereof. Image processing and machine learning system 400 can include third-party server(s) 414. Third-party server(s) 414 implement various functionalities, such as, inter alia: machine learning, image recognition, automated application development, image pre-processing, electronic mail, database management, etc. Image processing and machine learning system 400 can interface with other systems via computer network(s) 410 (e.g. the Internet, LANs, WANs, local Wi-Fi, cellular data networks, enterprise network, etc.).

Image processing and machine learning system 400 can include AI/ML module 420. AI/ML module 420 can implement the AI/ML functionalities provided herein. AI/ML module 420 obtain a set of training digital images of computer screens and associated contextual actions. Based on input from image processing module 402, AI/ML module 420 can use a machine learning algorithm (e.g. ANN, DNN, CNN, etc.) to build and train a machine learned classifier (e.g. machine learned classifier 422) with the set of training digital images of computer screens and associated contextual actions. AI/ML module 420 can implement statistical classification identify to which of a set of categories an observation (e.g. from mobile device(s) with digital camera 418) belongs on the basis of a training set of data.

Machine learned classifier 422 can use the image obtained a digital camera of a computer screen (e.g. from mobile device(s) with digital camera 418) to build an understanding of the digital image, build an understanding of the image’s content and/or the images context (e.g. within the application that generated the computer screen image). Machine learned classifier 422 can also then automatically suggest various actions to be taken based on the identity/classification of the image’s content and/or context.

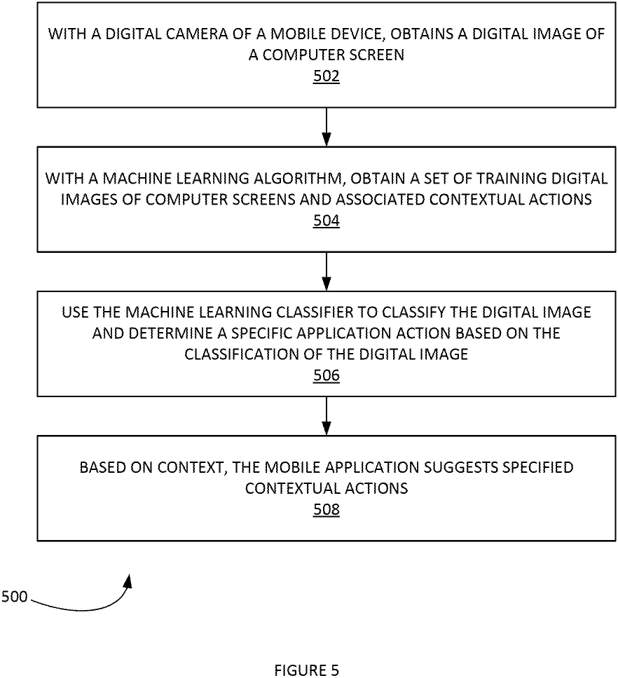

FIG. 5 illustrates an example process for computerized method for contextual smart computer vision, according to some embodiments. In step 502, with a digital camera of a mobile device, process 500 obtains a digital image of a computer screen, wherein the computer screen is displaying a specified computing application. In step 504, with a machine learning algorithm process 500 obtains a set of training digital images of computer screens and associated contextual actions, and uses the machine learning algorithm to build and train a machine learning classifier based on the set of training digital images of computer screens and associated contextual actions. In step 506, process 500 uses the machine learning classifier to classify the digital image and determine a specific application action based on the classification of the digital image. In step 508, process 500, based on context, the mobile application suggests specified contextual actions.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by united states patent:

1. A computerized method for contextual smart computer vision comprising:
with a digital camera of a mobile device, obtaining a digital image of a computer screen, wherein the computer screen is displaying a specified computing application;
with a machine learning algorithm:
obtaining a set of training digital images of computer screens and associated contextual actions, and
using the machine learning algorithm to build and train a machine learning classifier based on the set of training digital images of computer screens and associated contextual actions; and
using the machine learning classifier to classify the digital image and determine a specific application action based on the classification of the digital image; and
based on context, the mobile application suggests specified contextual actions.

2. The computerized method of claim 1, wherein the computer screen is integrated into a laptop computer system.

3. The computerized method of claim 1, wherein the computer screen is integrated into a desktop computer system.

4. The computerized method of claim 1 further comprising:
a specific window within the computer screen.

5. The computerized method of claim 1, wherein the machine learning algorithm comprises an artificial neural network.

6. The computerized method of claim 5, wherein the machine learning algorithm comprises a deep neural network.

7. The computerized method of claim 1 further comprising the step of:
using the machine learning classifier to build an understanding of the digital image.

8. The computerized method of claim 7 further comprising the step of:
using the machine learning classifier to build an understanding of the a content of the digital image.

9. The computerized method of claim 8 further comprising:
using the machine learning classifier to build an understanding the context of the digital image within the computer screen context.

10. The computerized method of claim 9 further comprising:
using the machine learning classifier to build an understanding the context of the digital image within the specified computing application displayed on the computer screen.

11. The computerized method of claim 1, wherein the context action comprises a live context sharing between the computing system and the mobile phone.
